(19) United States
(12) Patent Application Publication
(10) Pub. No.: US 2011/0066511 A1
(43) Pub. Date: Mar. 17, 2011

(54) Method of advertising in the real estate industry using an art

(76) Inventor: Eftim Cesmedziev, San Pedro, CA (US)

(21) Appl. No.: 12/584,883

(22) Filed: Sep. 14, 2009

(51) Int. Cl. G06Q 30/00; G06Q 90/00

(52) U.S. Cl. 705/14.73; 705/500

(57) ABSTRACT

A method of advertising in real estate industry using an art, where art(s) is used as a permanent real estate advertising tool for private and/or commercial property. On the outside visible surface of the art(s) is placed real estate agent advertising information and like that the art(s) is placed in the people's properties.

### RELATED APPLICATION

Not applicable

### STATEMENT REGARDING STATE SPONSORED RESEARCH OF DEVELOPMENT

Not applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R., section 1.14.

### FIELD OF INVENTION

The present invention generally relates to real estate business and businesses related around the real estate businesses, and more specifically, to method of advertising in the real estate industry.

### BACKGROUND OF THE INVENTION

After a buying a real estate property, the new owner of the property usually is targeted by many real estate agents with their advertising material. The advertising material usually is a note book with printed advertising information on it, pen with same or similar information printed on its outside surface, refrigerator magnets with advertising information printed on its outside surface, etc. All those advertising materials have a limited time of rise, where when time passes they are trashed because they are useless. From time to time the real estate agent sends another advertising material to the property owner that has same problem: limited time of use. The effectiveness of the relation between real estate agent and the property owner is very important for success of the real estate industry.

Currently, there is a lack of a reliable revenue structure and business model in real estate industry that address these issue and solution to solve these problem.

Therefore, an object of the present invention is to provide a new business model for advertising in real estate industry that will not be timely limited by the use of the advertising material. With implementing of this invention, the relations between all involved parts in the real estate industry and the property owner will be improved.

### BRIEF SUMMARY OF THE INVENTION

The general purpose of the present invention, which will be described subsequently in detail later, is to provide method of advertising in real estate industry using the art, heretofore as a prior art and novel features that which is not anticipated, rendered obvious, suggested, or even implied by any of the prior art, either alone or in any combination thereof.

Moreover, one embodiment of the present invention includes one or more free art gift(s) given by the real estate agent to the property owner, where the property owner will use the free art gift(s) to decorate the walls of the property, private and/or commercial.

Another embodiment of the present invention includes survey given to the property owner by a real estate agent, where the property owner answer all questions from the survey that are related to the needs and desires of the property owner regarding the placing the given art(s) in the his/her property.

Another embodiment of the present invention includes art(s) that has advertising information placed on its outside visible surface of the art(s), where those advertising information may contain information, such as, but not limited to, phone number, website address, physical address, person's name, logo, pager number, text message number, and any other advertising information known in the business of advertising industry.

Another embodiment of the present invention includes real estate agent that order the art(s) to be made, according the needs of the property owner, where the art is made based on the opinion expressed by the property owner in the survey. The real estate agent gives all information that want to be placed on the outside visible surface of the art(s), to the person(s) and/or company(es) who will produce the art(s). The person(s) and/or company(es) has a business contract with the real estate agent and/or real estate company, where the real estate agent and/or real estate company covers all expenses for producing the art(s).

Another embodiment of the present invention includes art(s) made according the property owner's desire and it is placed at the desired place in the property owner's property, where the advertising information may be clearly visible. Advertising information placed on the outside visible surface of the art(s) may be made from any material, using any known printing technology, such as, but not limited to screen and offset printing, stamping, writing, drawing and/or placing a sticker on the art(s) outside visible surface.

Another embodiment of the present invention includes offer from the real estate agent to the property owner to replace the art(s) with new art(s). In this way the real estate agent may offer a new survey to the property owner to get updated information about the property and its future.

Another embodiment of the present invention includes art(s) with advertising information placed on its outside visual surface that may be offer to the furniture store(s) and/or retail store(s) as a gift to everyone who will buy products from the store(s). In this way, the art(s) will be part of the household together with the advertising information.

Another embodiment of the present invention includes a website that is offered to the property owner where the property owner may see, choose and request a different art(s). The property owner has free and full access to visit that website, and full access to any know activity on that website as is already known in the prior art in computer technology, internet technology and website industry. It may be given option, where everyone who is visiting that website may buy an art with advertising information placed on the outside visible surface of the art. The information given by the property owner on the website is directly send to the real estate agent, where real estate agent, analyzing the request, makes decisions about the giving the gift to the property owner.

In this respect, before explaining at least one embodiment of the invention in greater detail, it is to understand that invention is not limited in its application to the details and steps of construction and to arrangements of the components/steps set forth in the following description. The invention is capable of other embodiments and of being practiced and carried out in various ways. In addition, it is to be understood that the phraseology and terminology employed herein is for the purpose of description and should not be regarded as limiting.

As such, those skilled in the art will appreciate that the conceptions, upon which this disclosure is based, may readily be utilized as a basis for the designing of other structures, devices, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

### DEFINITIONS OF TERMS

The terms “real estate agent” and “real estate company” herein denote everyone who is involved in the process of buying/selling a real estate property and who wants to advertise its business, such as, but riot limited to a real estate agent, a group of real estate agents, real estate company, property insurance agent and/or property insurance company, property inspector, property appraisers, property broker, and any other business that is related to the real estate business known in the prior art of the real estate industry.

The term “art(s)” herein denotes any creative work(s) made in two or more dimensions, and is made from any material, in any form and shape, in any color and any size, where an advertising information may be placed on its outside, visible surface, such as, but not limited to any type of photography, graphic design, graphic, drawing, illustration, any kind of painting, any kind of sculpture, and any other artistic form of expression known in the prior art in the art industry.

The term “advertising information” herein denotes any form of advertising information that may be placed on the outside, visible surface of the art(s) using any technique of placing the advertising information of the visible surface of the art(s) and contain advertising information, such as, but not limited to, phone number, website address, physical address, person's name, logo, pager number, text message number, and any other advertising information known in the business of advertising and communication industry, using any known printing technology, such as, but not limited to screen and offset printing, stamping, writing, drawing and/or placing a sticker over the art's outside front surface, and any other way of placing information on an outside art surface and elements around the art, such as, but not limited to, mat board that goes. around the art and/or glass, clear plastic and/or any other clearly visible surfaces that can be successfully and adequately use in the art industry and framing industry.

The term “manufacturing art” herein denotes any person(s) and/or business(s) that has any type of business agreement with real estate agent and/or real estate company or any other involved side, to create an art(s) according the order given by real estate agent and/or real estate company or any other involved side, to know all fazes of producing the art and to deliver the quality manufactured art(s) to the real estate agent and/or real estate company or any other involved side.

The term “outside visible surface” herein denote any advertising information placed on the front visible surface of the art(s) and/or on the front outside visible surface on the mat board that goes around the art and/or the front outside surface of a glass or clear plastic material that is used in framing industry, any other front clearly visible surface on the art(s), such as, but not limited to glass, laminating material(s), clear plastic and/or any other clearly visible surfaces, where advertising information may be successfully and adequately placed.

### DETAILED DESCRIPTION OF THE PREFERRED EMBODIMENTS

Aspects of the invention may be practiced using any suitable arrangement of the elements of the invention. Several different embodiments are described for purposes of illustration herein.

The invention, as an embodiment is made of a few steps offered to a person and/or property owner, such us, but not limited to:

a) real estate agent offer to a property owner a free art gift(s);

b) after accepting the offer free art gift(s), the property owner is expressing its needs and desires to the real estate agent;

c) in order to know what kind of art the property owner want to have, the real estate agent offer a survey to the property owner with questions about property owner desires, needs, opinions and any other information that will help to determinate what art(s) the property owner want to have;

d) after filing out the survey, the property owner give the survey to the real estate agent, where the real estate agent together with the property owner finalizing the art gift(s), what kind of art(s) it will be, or the number of arts that will be given to the property owner as well other relevant needs of the owner;

e) with those finalized information given by the property owner to the real estate agent, the real estate agent gives order to a person(s) and/or company(es) that will manufacture the art(s), where all manufacturing expenses will be covered by the real estate agent and/or real estate company;

f) a person(s) and/or company(es) that is manufacturing the art(s), manufacture the art(s) using any known ways to produce a quality art(s), placing all advertising information adequately and functionally on the front outside visual surface of the art(s) given by the real state agent; then, the person(s) and/or company(es) that is manufacturing the art(s) deliver the produced art(s) to the real estate agent, after receiving the payment from the real estate agent for the manufactured art(s);

g) the real estate agent together with the manufactured art(s) goes to the property owner, and together with the property owner they are placing the art(s) at the desired place;

h) from time to time the real estate agent may contact the property owner offering him/her a new free art gift(s) for refreshing the walls of the property, which will bring a fresh new look inside the property, and the real estate agent will have chance to know what are the property owner plans for the property; if the property owner want to get another property, then the real estate agent may help him/her;

i) the step h) may be repeated unlimited numbers of times;

j) the real estate agent may offer its free art gift(s) to customers that are shopping in different businesses, such as, but not limited to, a furniture store(s), or a retail store(s), or hotel(s), motel(s), commercial building(s) and mall(s), hospital(s), and any other place that has walls that needs art(s);

k) the real estate agent may offer the art(s) to everyone who want to buy an art thru a real estate company website, using an already well known technology and process in the prior art(s) of computers industry, interne and websites industries.

One embodiment of the invention is that one or more free art gift(s) may be given by the real estate agent to the property owner, where the owner will use the free art gift(s) to decorate the walls of the property, private and/or commercial. The real estate agent is deciding how many free art gift will be given to the property owner, what kind of art(s) and what information real estate agent want to place on the outside visible surface of the art(s).

Another embodiment of the invention is that after offering the free art gift(s) to the property owner, the real estate agent offers a survey to the property owner. The survey contains questions about the art(s), about the property, about the place where the owner wants to place the art(s), suggestions from the property owner about the art, such as, but not limited to, where the property owner will place the art(s), what kind of form of art(s), what color(s), size and form, and any other relevant question that will help to fulfill all needs of the property owner. The survey may be printed on a piece of paper and/or posted on a website, where the property owner has a full access to visit that website, and full access to any know activity on that website as is already known in the prior art in computer technology, interne and website industries.

Another embodiment of the invention is that after collecting all necessary information by the real estate agent, the real estate agent gives an order for art(s) to be produced to a person(s) and/or company(es) that are qualified to produce quality art(s), with real estate agent and/or real estate company advertising information successfully and adequately placed on the outside visible surface of the art(s). The art(s) are made based on the answers given by the property owner on the survey. A person(s) and/or company(es) that are qualified to produce quality art(s) must to produce an art(s) according the property owner instructions. Advertising information placed on the outside visible surface of the art(s) may be made from any material, using any known printing technology, such as, but not limited to screen and offset printing, stamping, writing, drawing and/or placing a sticker on the art(s) outside visible surface. The business contract between the real estate agent and the person and/or company that will produce the art(s) has covered all area of business relations that is well known in the prior art of business. The real estate agent and/or real estate company will cover all expenses for producing the art(s). The advertising information may contain information about the real estate agent and/or real estate company, such as, but not limited to, phone number, website address, physical address, person's name, logo, pager number, text message number, and any other advertising information known in the business of advertising industry. The real estate agent and/or real estate company is deciding what information wants to be placed on the outside visible surface art(s).

Another embodiment of the invention is that after producing the desired art(s), the real estate agent brings the art(s) to the property owner. The art(s) is placed at the desired place by the property owner or by the real estate agent, where the advertising information may be clearly constantly visible on the outside visible surface of the art(s).

Another embodiment of the invention is that the real estate agent may frequently contact the property owner offering a new art(s) to the owner, offering to the owner a new survey for the new needs of the owner. The real estate agents may have additional business relations with other businesses that produce products and services that are related to the property owners needs, and all those business relations are regulated in a way already known in the prior art in business industry. The real estate agent may offer them those products and services to the property owner. For example, if the real estate agent sees that property owner has needs of furniture, the real estate agent may offer to the property owner, a company that is selling and/or producing furniture at discounted price. In this way, the real estate agent may get additional commission from the furniture businesses. Also, the property owner gets furniture at good price. Previously, the real estate agent made a business contract with retail store(s) (in these example is a furniture store).

One embodiment of the invention is that the real estate agent and/or real estate company may offer to other businesses art(s) with real estate agent and/or real estate company advertising information placed on the outside visible surface of the art(s). Those businesses may be from different business industries, such as, but not limited to, a furniture store(s), hotel(s), motel(s), hospital(s), commercial building(s) and other store(s), where an art(s) with an advertising information placed on the outside visible art(s) surface is given as a gift to everyone who will buy product(s) and service(s) from the store(s).

Another embodiment of the invention is that the real estate agent may offers art(s) to the property owners that are advertised on a website, which is easily accessibly by the property owner. The property owner may see, choose and request another offered art(s) from a multitudes of art(s) posted on the website. The property owner has own username and password given by the real estate agent, where the owner has an access to visit that website, and all process of ordering a product is made in a way that is already known in the prior art in computer industry, internet industry and website industry. It may be given option to everyone who is visiting that website that may buy an art(s) with advertising information placed on the outside visible surface of the art(s). The information given by the property owner on the website is directly connected to a designated the real estate agent for that certain property owner, where real estate agent is deciding the rules of giving the desired art gifts. The communication between the real estate agent and property owner thru the website is well known method of communication in the prior art of internet.

Having described the principles of my invention, it should be apparent that these steps of the invention are basic steps and that more steps may be added within the method. Also, it should be apparent that these steps of the invention are basic steps and that more steps may be added within the method. From the foregoing, it will be appreciated that, although specific embodiments of the invention have been described herein for the purposes of illustration, various modifications may be made without deviating from the spirit and scope of the invention. Accordingly, I claim all steps and modifications as many come within the scope and spirit of the following claims.

I claim:

1. A method of advertising in real estate industry using an art comprising:
a) real estate agent offer to a property owner a free art gift(s);
b) a property owner accept the offered free art gift(s) and is expressing its needs and desires to the real estate agent;
c) the real estate agent offer a survey to the property owner with questions about property owner desires, needs, opinions and any other information that will help to determinate what art the property owner want to have;
d) the property owner give the answered survey to the real estate agent, where the real estate agent together with the property owner finalizing the art gift(s), what kind of art(s) it will be, or the number of art(s) that will be given to the property owner as well other relevant needs of the owner;
e) the real estate agent gives order to a person(s) and/or company(es) that will manufacture the art, where all manufacturing expenses will be covered by the real estate agent and/or real estate company and/or any other person and/or any other company;
f) a person(s) and/or company(es) that is manufacturing the art(s), manufacture the art(s) using any known ways to produce a quality art(s), placing all advertising information on the front outside visual surface of the art given by the real state agent; then, the person(s) and/or company(es) that is manufacturing the art(s) deliver the produced art(s) to the real estate agent, after receiving the payment from the real estate agent for the manufactured art;
g) the real estate agent, together with the manufactured art(s) goes to the property owner, and together with the property owner they are placing the art(s) at the desired place;
h) from time to time the real estate agent may contact the property owner offering him/her a new free art gift(s) for refreshing the walls of the property, which will bring a fresh new look inside the property, and the real estate will have chance to know what are the property owner plans for the property;
if the property owner want to get another property, then the real estate agent may help him/her;
i) the step h) may be repeated unlimited numbers of times;
j) the real estate agent may offer its free art gift(s) to customers that are shopping in different businesses, such us, but not limited to, a furniture store(s), or a retail store(s), or hotel(s), motel(s), commercial building(s) and mall(s), hospital(s), and any other place that has walls that needs art(s);
k) the real estate agent may offer the art to everyone who want to buy an art thru an real estate company website, using an already well known technology and process in the prior art of computer technology, interne and websites technologies.

2. A method as recited in claim 1, wherein said real estate agent and/or real estate company further includes real estate agent and/or real estate company where everyone who is involved in the process of buying/selling a real estate property and who wants to advertise its business, such as, but not limited to a real estate agent, a group of real estate agents, real estate company, property insurance agent and/or property insurance company, property inspector, property appraisers, property broker, and any other business that is related to the real estate business known in the prior art of the real estate industry;

3. A method as recited in claim 1, wherein said art(s) further includes any creative work(s) made in two or more dimensions, and is made from any material, in any form and shape, in any color and any size, where an advertising information may be placed on its outside, visible surface, such as, but not limited to any type of photography, graphic design, graphic, drawing, illustration, any kind of painting, any kind of sculpture, and any other artistic form of expression known in the prior art in the art industry;

4. A method as recited in claim 1, wherein said advertising information further includes:
a) any form of advertising information that may be placed on the outside visible surface of the art(s) using any technique of placing the advertising information of the outside visible surface of the art(s);
b) the advertising information may be contain information, such as, but not limited to, a phone number, a website address, a physical address, person's name, logo, pager number, text message number, and any other advertising information known in the business of advertising and communication industry;
c) the advertising information may be placed on the outside visible surface of the art(s) using any known printing technology, such as, but not limited to screen and offset printing, stamping, writing, drawing and/or placing a sticker over the art's outside front surface, and any other way of placing information on an outside art surface and elements around the art, such as, but not limited to, mat board that goes around the art and/or glass, clear plastic and/or any other clearly visible surfaces that can be successfully and adequately use in the art industry and framing industry;

5. A method as recited in claim 1, wherein said manufacturing art(s) further includes any person(s) and/or business(s) that has any type of business agreement with real estate agent and/or real estate company or any other involved side, to create an art(s) according the order given by real estate agent and/or real estate company or any other involved side, to know all fazes of producing the art(s) and to deliver the quality manufactured art(s) to the real estate agent and/or real estate company or any other involved side;

6. A method as recited in claim 1, wherein said outside visible surface further includes any advertising information placed on the front visible surface of the art(s) and/or on the front outside visible surface on the mat board that goes around the art(s) and/or the front outside surface of a glass or clear plastic material that is used in framing industry, any other front clearly visible surface on the art(s), such as, but not limited to glass, laminating material(s), clear plastic and/or any other clearly visible surfaces, where advertising information may be successfully and adequately placed;

7. A method as recited in claim 1, wherein said free art gift(s) further includes free art gift(s) where one or more free art gift(s) may be given by the real estate agent to the property owner, where the owner will use the free art gift(s) to decorate the walls of the property, private and/or commercial, and the real estate agent is deciding how many free art gift will be given to the property owner, what kind of art(s) and what information real estate agent want to place on the outside'visible surface of the art(s);

8. A method as recited in claim 1, wherein said survey further includes:
a) a survey may contains questions about the art(s), about the property, about the place where the owner wants to place the art(s), suggestions from the property owner about the art, such as, but not limited to, where the property owner will place the art(s), what kind of form of art(s), what color(s), size and form, and any other relevant question that will help to fulfill all needs of the property owner;
b) a survey may be printed on a piece of paper and/or posted on a website, where the property owner has a full access to visit that website, and full access to any know activity on that website as is already known in the prior art in computer technology, interne and website industries;

9. A method as recited in claim 1, wherein said art(s) further includes:
a) a real estate agent gives an order for art(s) to be produced to a person(s) and/or company(es) that are qualified to produce quality art(s), where a real estate agent and/or real estate company advertising information successfully and adequately will be placed on the outside visible surface of the art(s);
b) an art(s) is made based on the answers given by the property owner on the survey;
c) a person(s) and/or company(es) that are qualified to produce quality art(s) must to produce an art(s) according the property owner instructions;
d) an advertising information placed on the outside visible surface of the art(s) may be made from any material, using any known printing technology, such as, but not limited to screen and offset printing, stamping, writing, drawing and/or placing a sticker on the art(s) outside visible surface;
e) the business contract between the real estate agent and the person(s) and/or company(es) that will produce the art(s) has covered all area of business relations that is well known in the prior art of business;
f) the real estate agent and/or real estate company will cover all expenses for producing the art(s);
g) an advertising information placed on the outside visible surface of the art(s) may contain information about the real estate agent and/or real estate company, such as, but not limited to, phone number, website address, physical address, person's name, logo, pager number, text message number, and any other advertising information known in the business of advertising industry;
h) the real estate agent and/or real estate company is deciding what information wants to be placed on the outside visible surface art(s);

10. A method as recited in claim 1, wherein said real estate agent further includes real estate agent that brings the art(s) to the property owner after producing the desired art(s), where the art(s) is placed at the desired place by the property owner or by the real estate agent, where the advertising information may be adequately and functionally visible on the outside visible surface of the art(s);

11. A method as recited in claim 1, wherein said real estate agent further includes:
a) a real estate agent that may frequently contact the property owner offering a new art(s) to the owner, offering to the owner a new survey for the new needs of the owner;
b) a real estate agents may have additional business relations with other businesses that produce product(s) and service(s) that are related to the property owners needs, and all those business relations are regulated in a way already known in the prior art in business industry;
c) a real estate agent may offer them those product(s) and service(s) to the property owner;
d) real estate agent may get additional commission from the other businesses, where a real estate agent may make a business contract with other businesses;

12. A method as recited in claim 1, wherein said real estate agent further includes:
a) a real estate agent and/or real estate company may offer to other businesses art(s) with real estate agent and/or real estate company advertising information placed on the outside visible surface of the art(s);
b) those businesses may be from different business industries, such as, but not limited to, a furniture store(s), hotel(s), motel(s), hospital(s), commercial building(s) and other store(s), where an art(s) with an advertising information placed on the outside visible art(s) surface is given as a gift to everyone who will buy product(s) and service(s) from the store(s);

13. A method as recited in claim 1, wherein said real estate agent further includes a real estate agent and/or real estate company where:
a) offers art(s) to the property owners that are advertised on a website, which is easily accessibly by the property owner;
b) the property owner may see, choose and request another offered art(s) from a multitudes of art(s) posted on the website;
c) the property owner has own username and password given by the real estate agent, where the owner has an access to visit that website, and all process of ordering a product is made in a way that is already known in the prior art in computer industry, internet industry and website industry;
d) gives free and full access to a website that is easily accessibly to everyone who is visiting that website that may buy an art(s) with advertising information placed on the outside visible surface of the art(s);
e) the information given by the property owner on the website is directly connected to a designated the real estate agent for that certain property owner, where real estate agent is deciding the rules of giving the desired art gifts;
f) the communication between the real estate agent and property owner thru the website is well known method of communication in the prior art of internet technology;

14. A method as recited in claim 1, wherein said a method of advertising in real estate industry using an art further includes a method of advertising in real estate industry using an art where a various modifications may be made without deviating from the spirit and scope of the invention and accordingly, I claim all steps and modifications as many come within the scope and spirit of the claims.
